(19) United States
(12) Patent Application Publication
(10) Pub. No.: US 2003/0211822 A1
(43) Pub. Date: Nov. 13, 2003

(54) Motor vehicle with a system for ventilation of a compartment that is able to house a domestic animal

(75) Inventors: Piero Perlo, (US); Gianfranco Innocenti, (US); Valentina Grasso, (US)

Correspondence Address: SUGHRUE, MION, ZINN, MACPEAK & SEAS, PLLC, 2100 Pennsylvania Avenue, N.W., Washington, DC, 20037-3202, US

(73) Assignee: C.R.F. SOCIETA CONSORTILE PER AZIONI

(21) Appl. No.: 10/429,738

(22) Filed: May 6, 2003

(30) Foreign Application Priority Data
May 7, 2002 (IT) T02002A000374

(51) Int. Cl. B60H 1/00; B60H 1/26

(52) U.S. Cl. 454/141

(57) ABSTRACT

A motor vehicle comprises a vehicle body, inside which there are defined a passenger compartment, designed to house one or more persons, and a rear loading compartment, which is able to house at least one domestic animal. In the vehicle body there are defined at least one inlet passage for conveyance of air from outside the motor vehicle to the rear compartment and at least one outlet passage for expulsion of air from the rear compartment to outside the motor vehicle, for the purposes of:

creating a separation of the aerodynamic flows between the passenger compartment and the rear compartment, where the animal is housed;

improving the conditions of respiration and of general well-being of the animal; and

aiding the elimination of unpleasant smells from the rear compartment for housing of the animal, and improving as a whole the quality of the air inside the passenger compartment.

### TEXT OF THE DESCRIPTION

The present invention relates to a motor vehicle comprising a vehicle body, inside which there are defined a passenger compartment, designed to house one or more persons, and a rear loading compartment, which is able to house at least one domestic animal. In recent times, there have been introduced solutions aimed at rendering more convenient and comfortable the transporting of domestic animals within the rear-loading compartment or boot of a motor vehicle, which is the area of the latter traditionally exploited for the purpose.

The solution most widely used consists in the provision of a separation grill, aimed at a separating in a secure way the passenger compartment of the motor vehicle, understood as the area housing the driver and the passengers, from the rear compartment, in which the animal is housed.

Other solutions envisage the use of anti-slip mats and/or protective mats, designed to be arranged in the boot of the motor vehicle, for improving the conditions of stability of the animal and for preventing, at the same time, deterioration of the motor vehicle itself. Further solutions envisage systems for harnessing the animal, so as to guarantee the safety of the latter in the case of collisions, sudden jerks or swerving of the motor vehicle, and to prevent the animal from possibly disturbing the passengers, allowing it at the same time a certain degree of comfort and a certain degree of mobility.

The present invention is based, however, upon the recognition of the fact that the well-being of the animal is linked, above all, to the conditions of the air present in the compartment which houses it in the motor vehicle and to the fact that, in the present state of the art, there do not exist specific solutions in this direction.

The approach followed for the purpose of enabling change of air in the area in which the transported animal is located is typically that of partially opening of one or more rear windows of the motor vehicle. This practice, in addition to not being effective for the purposes of increase in comfort of the animal transported, may lead to a certain degree of disturbance for the occupants of the vehicle, in addition to a worsening in the conditions of the air also within the passenger compartment.

In such a perspective, the purpose of the present invention is to provide a motor vehicle in which the air conditions in the compartment equipped for transporting an animal will be improved by means of a relatively simple, functional, and low-cost system.

The above and other purposes are achieved, according to the present invention, by a motor vehicle comprising a vehicle body, inside which there are defined a passenger compartment, designed to house one or more persons, and a rear loading compartment, which is able to house at least one domestic animal, characterized in that in the vehicle body there are defined at least one inlet passage for the conveyance of air from outside the motor vehicle to the rear compartment and at least one outlet passage for the expulsion of air from the rear compartment to outside the motor vehicle, the outlet end of the first passage and the inlet end of the second passage being in respective positions such as to induce the formation of a flow or current of air which circulates in the rear compartment following a substantially pre-defined or preferential path.

Preferred embodiments of the invention are specified in the attached claims, which are understood as forming an integral part of the present description.

Further purposes, characteristics and advantages of the present invention will emerge clearly from the ensuing description with reference to the annexed drawings, which are provided purely by way of non-limiting example and in which:

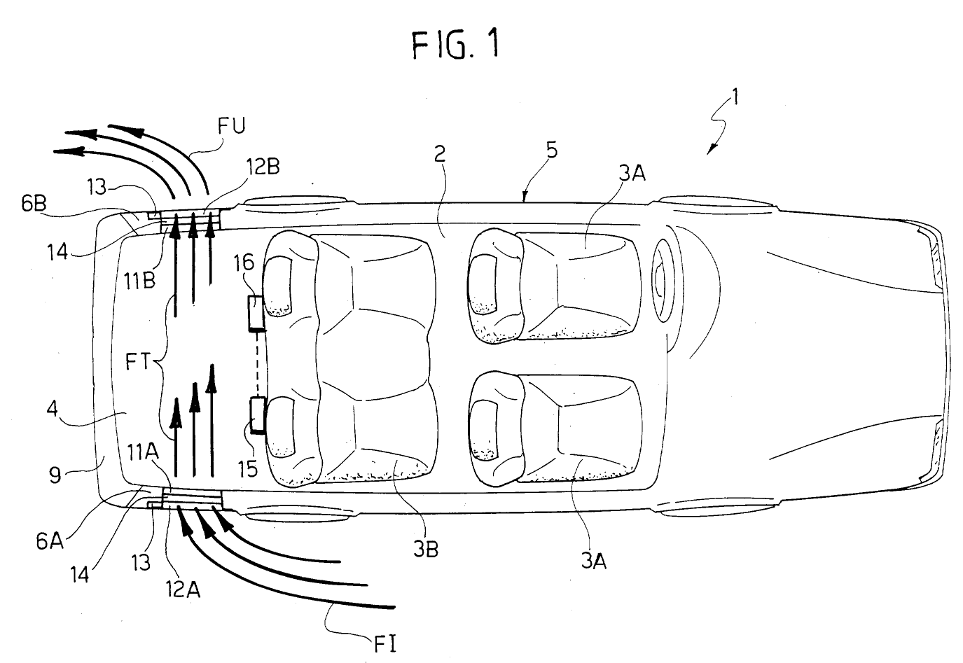

FIG. 1 is a schematic plan view and in partial cross section of a generic motor vehicle built in accordance with a first embodiment of the present invention,

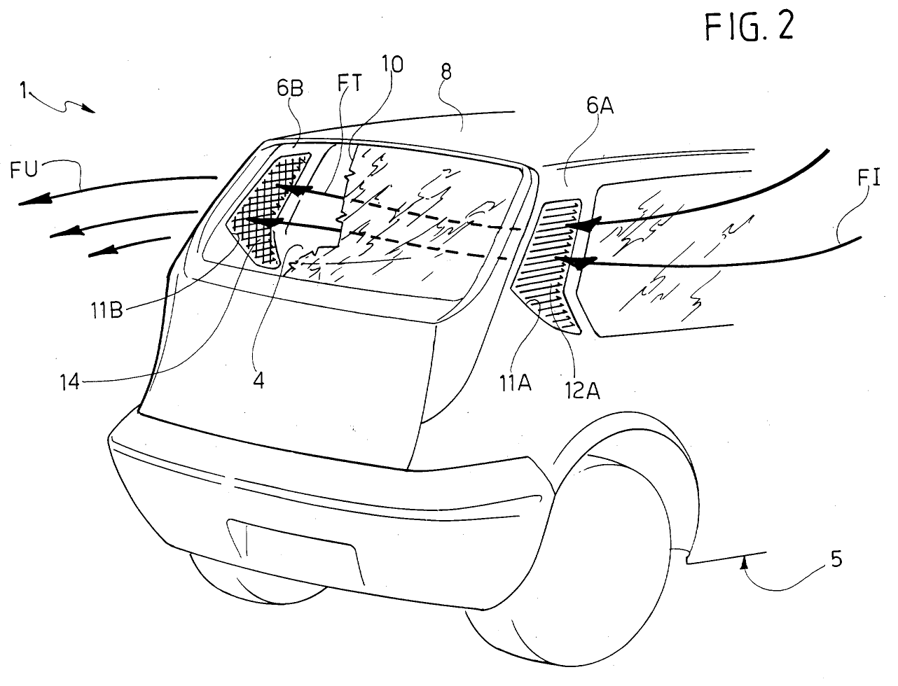

FIG. 2 is a schematic perspective view of the rear part of the motor vehicle of FIG. 1;

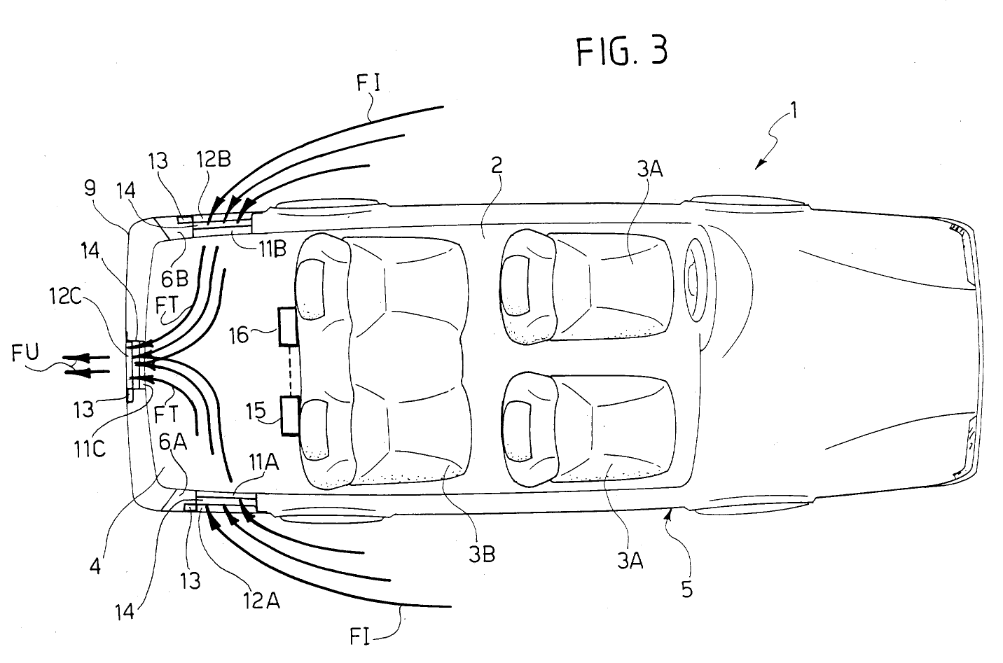

FIG. 3 is a schematic plan view in partial cross section of a generic motor vehicle built in accordance with a second possible embodiment of the present invention; and

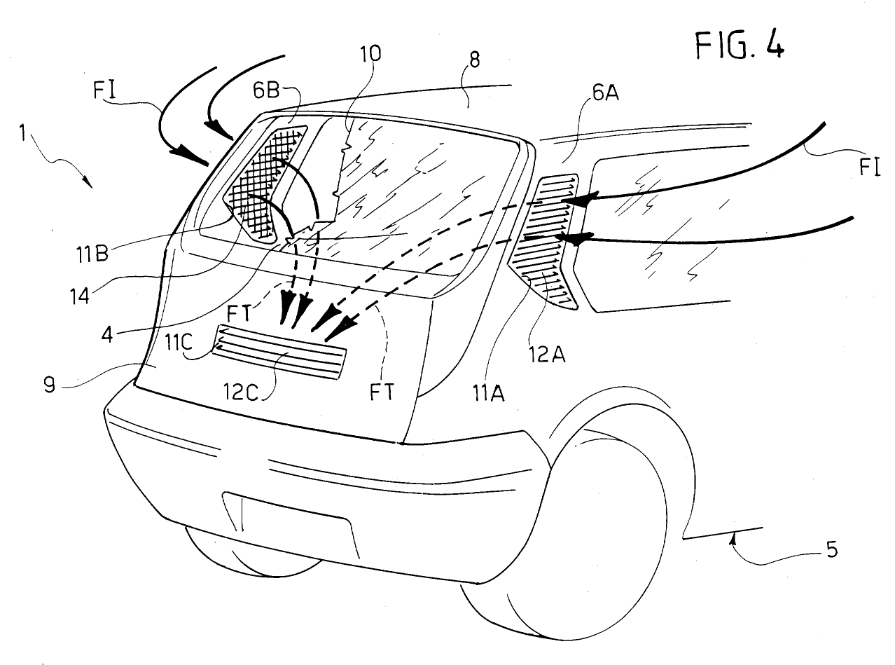

FIG. 4 is a schematic perspective view of the rear part of the motor vehicle of FIG. 3.

FIGS. 1 and 2 represent, with different views, a generic motor vehicle built in accordance with the present invention.

In the case provided by way of example, the motor vehicle is represented by a motor car, designated as a whole by 1, having a passenger compartment 2, within which are arranged two front seats 3A and a rear seat 3B; behind the seat 3 there is present a rear-loading compartment or boot 4.

The body 5 of the motor car 1 is designed in a way that is as a whole known and comprises for said purpose two rear uprights 6A and 6B for connection of the lower part of the bodywork to the roof of the motor car itself, designated by 8 in FIG. 2.

The body 5 likewise comprises side doors (not shown in the figures) and a rear door 9, provided for enabling access to the boot 4. The rear door 9, which is equipped with a respective window designated by 10 in FIG. 2, is hinged in a known way to the body 5, and in particular to its roof 8.

The motor car 1 likewise comprises all the elements, which are known to the art, for its operation, amongst which a system of ventilation or circulation of the air, comprising one or more passages which enable conveyance into the passenger compartment 2 of the air taken in from outside.

According to a first important aspect of the invention, in the body 5 of the motor car 1 there are defined at least two further passages, for inducing the formation of a flow of air which follows a preferential path within the boot 4. In the case provided by way of example, for this purpose two passages are envisaged, designated by 11A and 11B, each defined in a respective side upright 6A and 6B.

In a position corresponding to the external part of the passages 11A, 11B respective deflector members are installed, designated by 12A and 12B, comprising, for example, one or more mobile flaps or plates, which extend horizontally, as in the case represented in FIG. 2, or else vertically.

The deflector members 12A, 12B are equipped for the purpose with a respective system of movement, designated as a whole by 13 in FIG. 1, comprising actuator means made according to known technologies (for example, thermo-actuators, electromagnets, electric stepper motors or continuous electric motors, piezo-electric actuators or actuators made of shape-memory alloy, etc.).

Furthermore, possibly, between each deflector member 12A, 12B and the outlet of the respective passage 11A, 11B towards the inside of the boot 4, there may be provided filtering means, designated as a whole by 14 in FIGS. 1 and 2. The said filtering means 14 may be represented by a retention membrane, for example consisting of porous activated carbon with adsorbent action. The action of said filtering means 14 proves particularly useful in critical conditions of pollution (tunnels, traffic queues, etc.), with the possibility of enabling opening of the deflector members 12A, 12B also in the aforesaid conditions.

The system according to the invention is conceived for enabling circulation of air in the boot 4. For this purpose, in the case provided by way of example, the deflector member 12A set on the upright 6A is provided for enabling entrance of air, whilst the deflector member 12B set on the upright 6B is provided for enabling the subsequent outflow of the air. In this embodiment, the aerodynamic design of the system of air circulation thus envisages that the deflector member 12A is shaped for facilitating intake of the external air towards the inside of the boot 4, whilst the deflector 12B is shaped for favouring suction of the internal air from inside the boot 4, so as to cause it to flow outside the motor car 1.

Possibly, in accordance with a possible embodiment of the invention, there may likewise be provided sensor means or detecting means, designated as a whole by 15 in FIG. 1, for detection of one or more environmental or physical parameters, such as the presence of an animal in the boot 4, the ambient temperature, the speed of the flows of circulating air, the presence of smells, the presence of rain, the presence of pollutants, etc., the said sensor means being made using technology in itself known.

Finally, designated as a whole by 16 is a system for electronic control of the system described, which may also be readily understood by a person skilled in the art, for acquisition of data from the aforesaid sensor means 15, if these are provided, and in any case for managing the actuator means 13, also as a result of manual commands, for the purposes of regulation of the operating position of the deflector members 12A and 12B.

The system of ventilation or circulation of the air in the boot 4 which equips the motor car 1 according to the invention functions in the way described in what follows.

For the purpose of enabling entrance of the air into the boot 4, the control system 16 operates the actuator means 13, with the consequent partial opening of the deflector members 12A and 12B. The air can then penetrate inside the motor car 1 by means of the passage 11A and the deflector member 12A, with inlet flows designated by FI.

The inlet flows FI then traverse the filtering means 14, for elimination of any possible pollutants, pollens and fumes, and reach the boot 4, in which a domestic animal, such as a dog, is assumed to be housed. Given the special conformation and arrangement of the deflector members, the air follows a preferential path within the boot 4, between the inlet deflector member 12A and the outlet deflector member 12B, this path being represented by the flows designated by FT in FIGS. 1 and 2. The same air then flows off out of the boot 4 by means of the outlet deflector member 12B, giving rise to one of the outlet flows designated by FU.

The inlet flows FI are controlled by the deflector member 12A, the position of which is controlled by the actuator means 13. The latter are, as has been said, managed by the control system 16 following upon of a simple manual command issued by the driver or by a passenger of the motor car 1, or else on the basis of the environmental and dynamic conditions of the motor car 1, detected by the sensor means 15 (in this perspective, for example, the flow rate of air entering with the flows FI may be regulated by the system 16 in relation to the cruising speed of the motor car 1).

Note that, in the case where the filtering means 14 are not present, the control system 16 can be programmed for controlling the closing of the deflector members 12A, 12B according to detection effected by the sensor means 15. For example, in the case where there is provided a pollution sensor or external-temperature sensor and the value of pollution or temperature detected by the sensor exceeds a pre-determined threshold, the system 16 will automatically control closing of the deflector members 12A, 12B. Alternatively, once again in the absence of the filtering means 14, the closing of the deflector members could be associated to the shutting-off of the air circulation inside the passenger compartment 2.

As may be understood, the ventilation or circulation system described enables setting-up of an independent microclimate in the compartment designed for housing the animal, i.e., in the boot 4, with an evident improvement of the conditions of the air in terms of temperature, change, distribution and quality.

The system described thus proves evidently very useful for:

creating a separation of the aerodynamic flows between the space 2 of the driver and of the passengers and the space 4 where the animal is housed;

improving the conditions of respiration and of general well-being of the animal;

aiding the elimination of unpleasant smells from the compartment 4 for housing the animal and improving as a whole the quality of the air inside the passenger compartment 2.

FIGS. 3 and 4 represent a possible alternative embodiment of the invention. Note that in FIGS. 3 and 4 the same reference numbers are used as in FIGS. 1 and 2 for designating elements that are technically equivalent to the ones already indicated.

In the variant proposed, both of the passages 11A, 11B and the respective deflector members 12A and 12B are shaped and provided for favouring the entrance of air into the boot 4, by means of respective inlet flows FI. The outflow of the air from the boot 4 is, instead, enabled by means of a further deflector member, designated by 12C, substantially of the same type as the ones designated by 12A and 12B, installed in a respective passage 11C defined in the rear access door 9.

Also in this case, the deflector member 12C may comprise a series of mobile horizontal plates, as in the case represented, or mobile vertical plates, with a respective system of movement 13, managed by the control system 16.

In the case of the embodiment illustrated in FIGS. 3 and 4, the inlet flows FI form, within the boot 4, a current of air FT having a preferential path, directed towards the bottom part of the rear access door 9, in the outlet deflector member 12C, through which the air then flows away outside the motor car 1.

This arrangement thus enables outflow of the air from the side portions towards the rear side of the boot 4, not only for the purpose of supplying fresh and clean air to the animal, but also to enable the collection and subsequent elimination of any hairs and dust in an area that is readily accessible for the purposes of cleaning.

Of course, without prejudice to the principle of the invention, the details of construction and the embodiments may vary with respect to what is described and illustrated herein purely by way of example.

For instance, it is clear that the passages 11A and/or 11B for entrance into and/or outlet of the air from the rear compartment 4 could be made also in parts of the body or bodywork different from the rear uprights 6A, 6B, for instance on the sides of the motor vehicle 1.

The deflector members 12A, 12B and 12C, instead of comprising respective actuators of movement, could comprise active plates made of shape-memory alloy. As is known, shape-memory materials exploit the properties of some alloys of nickel and titanium, which undergo a contraction following upon heating up to a transition temperature.

Deflector members built in this way, in addition to requiring a very low power of supply and being extremely reliable and efficient, enable containment of the overall dimensions and weights of the system, so simplifying its constructional layout. The use of shape-memory materials for the fabrication of deflector members proves moreover of particular interest in the case of brief stops where the motor car 1 is standing still in the sun, with the engine turned off or when the user has forgotten to activate the control system for controlling the climate of the rear compartment 4. In this situation, the deflector members are in any case able to operate without the need for electric power, in so far as the partial opening thereof would be caused directly by the variation of the ambient temperature.

1. A motor vehicle comprising a vehicle body, inside which there are defined a passenger compartment, designed to house one or more persons and a rear loading compartment, which is able to house at least one domestic animal, wherein in the vehicle body there are defined at least one inlet passage for conveyance of air from outside the motor vehicle to the rear compartment and at least one outlet passage for expulsion of air from the rear compartment outside the motor vehicle, the outlet end of the first passage and the inlet end of the second passage being set in respective positions such as to induce formation of a flow or current of air, which circulates in the rear compartment following a substantially pre-defined or preferential path.

2. The motor vehicle according to claim 1, wherein operatively associated to the inlet passage, and preferably also to the outlet passage, is a respective deflector member.

3. The motor vehicle according to claim 2, wherein the deflector member comprises a respective system of movement.

4. The motor vehicle according to claim 3, wherein the deflector member comprises one or more flaps or plates moved by means of the system of movement.

5. The motor vehicle according to claim 2, wherein between at least one deflector member and one end of the respective passage, which faces inside the rear compartment filtering means are provided.

6. The motor vehicle according to claim 2, wherein the deflector member associated to the inlet passage is shaped for facilitating intake of the external air towards the inside of the rear compartment.

7. The motor vehicle according to claim 2, wherein the deflector member associated to the outlet passage is shaped for favouring suction of the internal air into the rear compartment, so as to cause it to flow outside.

8. The motor vehicle according to claim 2, wherein an electronic control system is provided for governing the system of movement of the deflector member, which operates for the purposes of regulation of the operating position of the latter.

9. The motor vehicle according to claim 8, wherein sensor means are operatively associated to the control system for the detection of one or more environmental or physical parameters.

10. The motor vehicle according to claim 9, wherein the control system is operative to manage the actuation of the system of movement of at least one deflector member according to measurements effected by means of the sensor means.

11. The motor vehicle according to claim 1, wherein the inlet passage and the outlet passage are each defined in a respective upright forming part of the vehicle body.

12. The motor vehicle according to claim 1, wherein the inlet passage is defined in a respective upright forming part of the vehicle body and in that the outlet passage is defined within a rear access door for access to the rear compartment, in particular in a bottom central portion of this rear door.

13. The motor vehicle according to claim 12, wherein there are provided two inlet passages, each defined in a respective rear upright forming part of the vehicle body.

14. The motor vehicle according to claim 1, wherein the inlet passage and outlet passage are each defined in a respective side of the vehicle body.

15. The motor vehicle according to claim 12, wherein there are provided two inlet passages, each defined in a respective side of the vehicle body.

16. The motor vehicle according to claim 4, wherein the flap or flaps of the deflector member are made of shape-memory alloy.
